(19) United States
(12) Patent Application Publication
(10) Pub. No.: US 2022/0131227 A1
(43) Pub. Date: Apr. 28, 2022

(54) BATTERY BOX

(71) Applicant: Reinz-Dichtungs-GmbH, Neu-Ulm (DE)

(72) Inventors: Franz SCHWEIGGART, Pfaffenhofen (DE); Axel RITZAL, Neu-Ulm (DE); Manfred RUED, Senden (DE)

(21) Appl. No.: 17/593,757

(22) PCT Filed: Mar. 25, 2020
(86) PCT No.: PCT/EP2020/058284

§ 371 Date: Sep. 23, 2021

(30) Foreign Application Priority Data
Mar. 25, 2019 (DE) 20 2019 101 682.5

(51) Int. Cl. H01M 50/249; B60L 50/64; B60L 50/60; H01M 10/625; H01M 10/658; H01M 50/24

(52) U.S. Cl. CPC H01M 50/249; B60L 50/64; H01M 50/24; H01M 10/625; H01M 10/658; B60L 50/66

(57) ABSTRACT

A The present invention relates to a battery box for a traction battery, as used to mount traction batteries in vehicles. The battery box comprising: a lower side, an upper side, an edge region extending between the upper side and the lower side, a plurality of battery modules arranged in the battery box, and a shielding element comprising at least two layers.

The present invention relates to a battery box for a traction battery, as used to mount traction batteries in vehicles.

Battery boxes for traction batteries usually have two housing parts which are connected to one another, namely a lower part in the form of a tray and an upper part in the form of a cover. The two housing parts are joined together and enclose the traction battery. The traction battery itself usually consists of a plurality of individual battery cells (battery modules), which are arranged next to one another and/or one above the other.

One particular problem with traction batteries is the risk of thermal runaway of defective cells, that is to say the spread of heat from cell to cell, and thus extremely rapid heating of the battery box, which may lead to flames breaking through the battery box to the outside.

Therefore, high-voltage battery boxes in particular are usually lined with materials resistant to high temperatures. However, such materials usually have little or no mechanical protection. Furthermore, they are difficult to keep in a 3D shape, and therefore the protective effect decreases over time under the mechanical load of the battery box during operation of the vehicle.

The object of the present invention is therefore to provide a battery box which prevents or at least significantly delays the breakthrough of flames and particles from the battery box to the outside, which is inexpensive to manufacture, and which also ensures the safety of the battery box over the long term.

This object is achieved by the battery box according to claim 1. Advantageous further developments of the battery box according to the invention are specified in the dependent claims.

As is customary in the prior art, the battery box according to the invention has a lower side, usually designed as a tray and occasionally also referred to as such below, and an upper side, usually designed as a cover and occasionally also referred to as such below. A plurality of battery modules are arranged in the battery box.

The battery box according to the invention is now configured in such a way that it has a high temperature resistance with a high degree of mechanical protection and reliably delays or completely prevents the breakthrough of flames from the battery box to the outside.

To this end, a flat shielding element formed of at least two layers is arranged between the battery modules and the upper side, that is to say the cover. Such a shielding element may also be arranged for shielding purposes between two battery modules. The battery modules may in this case be arranged horizontally next to one another, vertically next to one another, or adjacent to one another in some other way in the battery box. According to the invention, the shielding element has a first outer metal layer and a second outer metal layer, for example made of a metal sheet, wherein at least one metal layer of the outer layers, referred to hereinafter as the second outer layer, consists of or comprises a steel having a melting point Tₛ≥1000° C., for example a steel sheet. The shielding element is in this case arranged in such a way that the second outer layer made of steel is arranged adjacent to a battery module.

By virtue of the two-layer design, starting from the shielded battery module, the environment surrounding the battery module on the opposite side of the shielding element is effectively shielded against the effects of high temperatures. If the shielding element is located between two battery modules, a breakthrough of generated heat from one battery module to the adjacent battery module is significantly delayed or prevented. This therefore hinders the spread of an overheating of one battery module (a so-called “thermal runaway”) to the adjacent battery module.

If the shielding element is arranged between the battery modules and the upper side of the battery box (the cover), any spreading of the generated heat to the battery cover, and from there possibly further into the vehicle, can be prevented or at least significantly delayed. Due to the fact that the second outer layer adjacent to the shielded battery module consists of or comprises a steel having a melting point Tₛ≥1000° C., the shielding element itself is very temperature-resistant.

The first layer, which is located opposite the second outer layer, may consist of steel, in particular of steel sheet, for example if the shielding element is arranged between two battery modules, and can thus shield the adjacent battery modules from one another. However, if the shielding element is arranged between the battery modules and the upper side of the battery box, it is also advantageously possible to make the first outer layer, which is adjacent to the upper side of the battery box and is in turn shielded from the battery modules by the second outer layer, from a lightweight material such as, for example, aluminium or the like.

In addition to increasing the temperature resistance of a battery box, a number of advantages are thus simultaneously achieved.

On the one hand, the two-layer shielding element achieves a very high degree of thermal shielding of a battery module or of the battery modules with respect to the surrounding environment, for example a further battery module or an upper side of a battery box, and thus with respect to a vehicle. In regular operation, the very good thermal insulation properties of the shielding element serve to effectively maintain and operate the battery modules in their nominal temperature range.

The use of metal layers for the shielding element makes it possible to adapt the shielding element perfectly to the 3D shape of the upper side of the battery box, that is to say the cover/hood. Since the shielding element is self-supporting, easy installation in the hood is also possible. When using an aluminium sheet for the first outer layer, the weight of the shielding element is greatly reduced. Nevertheless, there is a high degree of thermal insulation both in regular operation, as well as a resistance to flaming or heating to high temperatures. Since very high temperatures of up to 1000° C. and above can occur during a thermal runaway of a battery cell, the heat-resistant second outer layer, which is resistant even to temperatures thereabove, ensures that the battery box as a whole is resistant for some time, in particular advantageously for at least 5 minutes. A breakthrough of the thermal runaway to the vehicle is therefore significantly delayed or prevented. The choice of metals as the material of the metal layers additionally provides mechanical protection for the battery modules.

According to the invention, a stainless steel, for example a 1.4301 steel, may be used for the second outer layer. It is also possible to use an aluminium-plated steel or a hot-dip aluminized steel for the second outer layer.

Particularly, but not only, in the case of battery modules arranged one above the other (that is to say adjacent in the vertical direction), the first and/or the second outer metal layer, preferably both, are made of stainless steel. These two stainless steel layers protect the shielding element, an adjacent battery module and also each other in the event that one of the adjacent battery modules is defective and heats up exceptionally. In addition, the stainless steel layers can easily bear the weight of one or more battery modules arranged thereabove.

If the first outer layer is likewise made of steel, the same materials may also be used for the second outer layer. However, if the first outer layer is made of aluminium, aluminium sheets of different thicknesses may be used. Usually, the aluminium sheet of the first outer layer is thicker than a steel sheet of the second outer layer. For the first layer, thicknesses D1 of 0.1 mm≤D1≤2.0 mm, advantageously 0.3 mm≤D1≤0.6 mm, are advantageously used as the maximum thickness of the layer or as the average thickness of the layer. The second layer, which consists of or comprises a steel sheet, advantageously has a thickness D2 as the maximum thickness of the layer or as the average thickness of the layer, where 0.1 mm≤D2≤1.0 mm, advantageously 0.1 mm≤D2≤0.3 mm, in particular a thickness of D2=0.15 mm.

One or both of the first outer layer and the second outer layer may be perforated, in particular microperforated, pierced or nubbed. As a result, it is possible for example to further improve the sound insulation provided by the shielding element and to achieve a further reduction in weight.

It is not absolutely necessary that a further insulation layer is located between the first outer layer and the second outer layer. However, it is advantageous if such an insulation layer is introduced between the two outer layers. For this insulation layer, it is advantageous if it consists of or contains a material which is stable up to at least 600° C. This is fulfilled, for example, by fibre materials such as glass fibres, rock wool, silicate fibres, or also by mica. Glass fibres coated with aluminium by vapour deposition are also suitable as a material for the insulation layer. Furthermore, suitably finished cardboards containing fillers, binders and other components are optionally also suitable as the insulation layer. Use may be made of cardboards as usually used in heat shields of internal combustion engines.

The insulation layer need not be self-supporting, and therefore use may in particular be made of a binder-free insulation layer. The mechanical stability of the insulation layer is ensured by the embedding thereof between the two outer layers. This now at least three-layered construction of the shielding element also prevents the insulation layer from being mechanically destroyed during operation of the vehicle and from being removed from the shielding element. It is true that the individual fibres and the like of the insulation layer may detach from one another or break during operation of the vehicle. However, since they are sufficiently enclosed between the two outer metal layers, they remain in their position and continue to contribute to the insulating effect of the shielding element.

In addition, one or both of the outer layers may be nubbed and/or pierced or may have structures embossed in any other way, for example beads and the like, including different structurings in combination. By structuring the surface in this way, the respective outer layer is kept at a distance from the adjacent component, for example the battery box cover, so that a further thermally insulating air gap can be formed therebetween.

One or both outer layers may also be pierced or perforated, thereby forming through-openings, for example in the form of a tanged metal sheet. The insulation layer may also penetrate these through-openings and thus be anchored at the respective position. Such a layer may also be at least partially embedded in the material of the insulation layer, for example as a tanged metal sheet embedded in an insulation layer consisting of NBR-bound mica.

Due to the fact that the shielding element can be pre-shaped into a 3D shape corresponding to the cover or corresponding to the battery module, it is not absolutely necessary to fixedly connect the shielding element to an adjacent component, for example by screwing, riveting, clamping and the like. It is often sufficient to place the shielding element in position in the battery box in loose form since it is held in the correct position by its 3D shape.

The battery box according to the invention is therefore effectively improved with regard to mechanical loads and its thermal insulation properties by the shielding element according to the invention, which is adapted to the requirements of a battery box of a traction battery or to the requirements of traction batteries. This improvement is in particular achieved inexpensively and with minimal additional weight.

A few examples of battery boxes according to the invention will be given below. The same and similar reference signs will be used for the same and similar components throughout, and therefore the repetition and description thereof may be omitted. In the examples below, a number of improvements to the present invention and further developments are described, each of which per se may also further develop the present invention or else may be combined with other further-developing measures of the same example or of other examples.

In the figures:

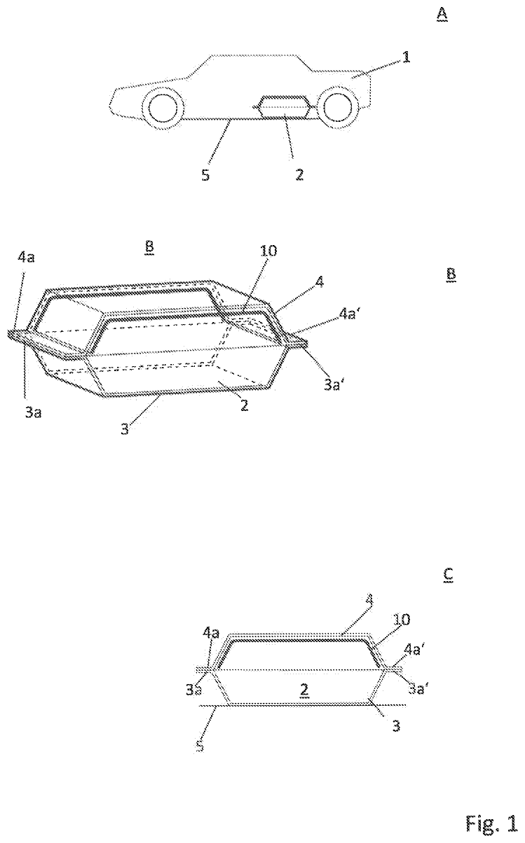

FIG. 1 shows, in the three sub-figures A, B and C, the arrangement and the structure of a battery box according to the invention;

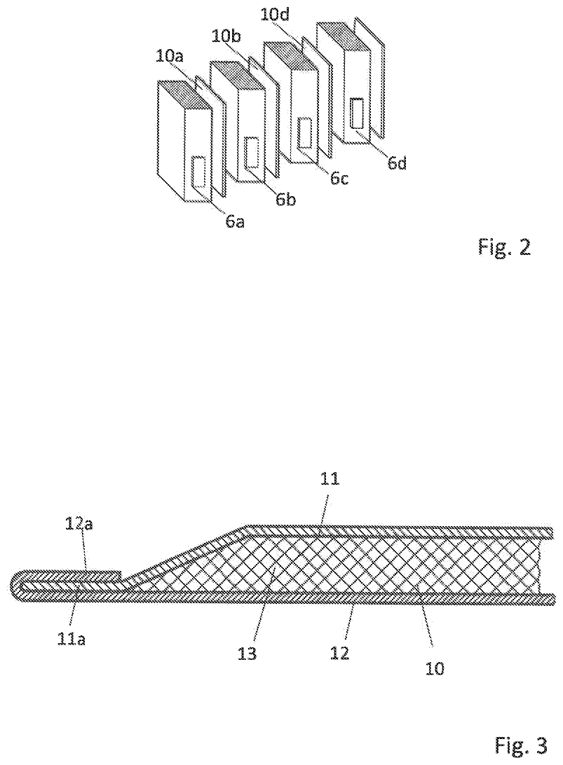

FIG. 2 shows the arrangement of battery cells in a battery box;

FIG. 3 shows a cross-section through a shielding element of a battery box according to the invention;

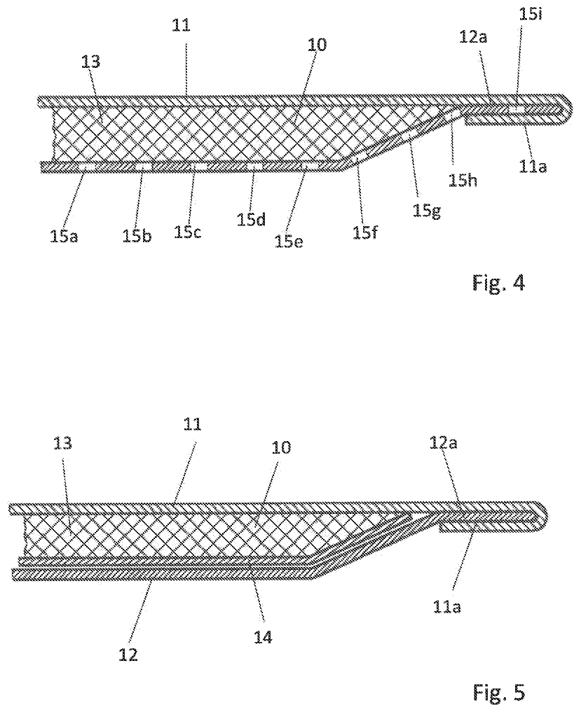

FIGS. 4-6 show cross-sections through further shielding elements of battery boxes according to the invention;

FIG. 7 shows examples of various materials for use as layers in shielding elements of battery boxes according to the invention;

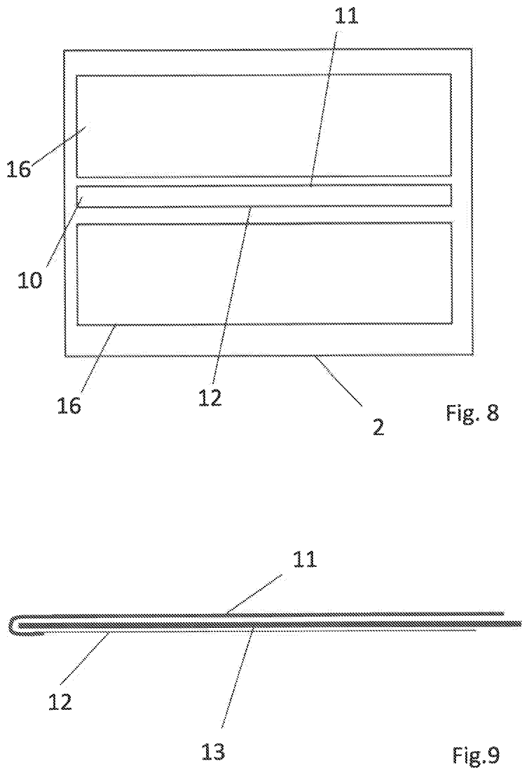

FIG. 8 shows an arrangement of battery cells one above the other in a battery box;

FIG. 9 shows a cross-section through the shielding element used in FIG. 8; and

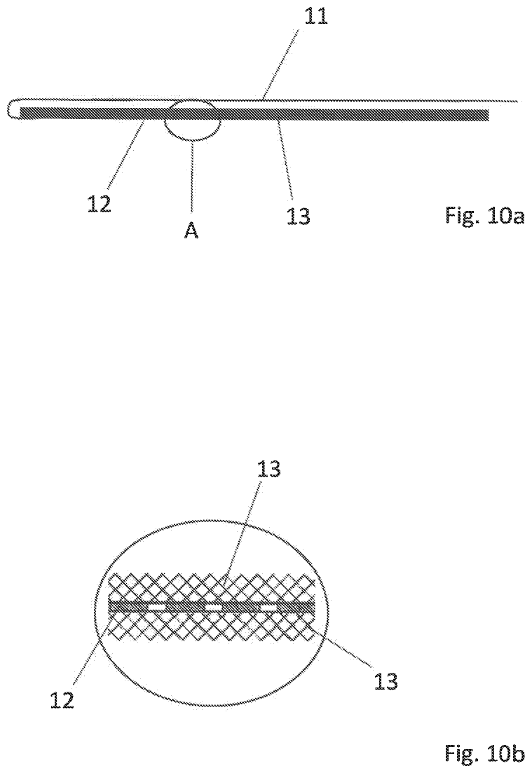

FIG. 10 shows a cross-section through a further shielding element.

FIG. 1 shows a vehicle 1 with a battery box 2, which is mounted on an underbody 5 of a vehicle.

FIG. 1A shows the vehicle 1, while FIGS. 1B and 1C respectively show a perspective view through the battery box and a plan view of a cross-section through the battery box.

According to sub-figures 1A, 1B and 1C, the battery box 2 has a lower side in the form of a tray 3 and an upper side in the form of a battery cover 4. Both the tray 3 and the cover 4 have flanges 3a, 4a and 3a′, 4a′, which in each case bear against one another in pairs and at which the tray 3 is connected to the cover 4. Arranged on the inner side of the cover 4 is a shielding element 10, which largely lines the cover 4 at the top and has a 3D shape corresponding to the 3D shape of the cover 4.

FIG. 2 shows a further arrangement according to the invention, in which shielding elements 10a, 10b, 10c are arranged between individual battery cells 6a, 6b, 6c and 6d of a traction battery.

FIG. 1 therefore shows a shielding of the inside of a battery box, in which a traction battery (not shown) is arranged, at the top in the direction towards the interior of the vehicle 1, while FIG. 2 shows a thermal shielding between individual battery cells of a traction battery, which are arranged in a corresponding battery box as shown in FIG. 1.

FIG. 3 shows part of a cross-section through a shielding element 10 of a battery box according to the invention. Here, as also in the subsequent figures, the shielding element 10 can be used both for shielding between a traction battery and a cover 4 of a battery box 2 and for shielding between two battery cells within a battery box 2.

In FIG. 3, the shielding element 10 has a first layer 11 consisting of an aluminium sheet having a thickness of 0.4 mm, a second layer 12 consisting of a stainless steel sheet having a thickness of 0.2 mm, and a third layer 13 as an insulation layer. The third layer 13 consists of mica.

At their edges, the two layers 11 and 12 are configured in such a way that the layer 11 has a flange 11a and the layer 12 has a crimp 12a, which bear flat against one another, the crimp 12a engaging around the flange 11a and thus completely closing off the shielding element 10 towards the outside. As a result, the mica of the layer 13 is completely enclosed between the layers 11 and 12 and, even in the event of its own internal mechanical stability being lost, cannot leave the shielding element 10.

FIG. 4 shows a further example of a shielding element 10 for use in battery boxes according to the invention.

The shielding element 10 is configured in a manner similar to that in FIG. 3. Now, however, the first layer 11 is made of an aluminium sheet having a thickness of 0.4 mm, and the second layer 12 is made of a pierced stainless steel sheet having a thickness of 0.2 mm or of a stainless steel mesh or a stainless steel grid having said thickness. The second layer 12 therefore has openings 15a to 15i, as well as further openings (not shown) which are spaced apart at regular intervals and make it possible for heat as well as sound to pass through the openings 15a to 15i into the third layer 13. The third layer 13 is a glass mat, for example made of ECR glass or silicate glass fibres, having a weight per unit area of, for example, 650 g/m² and a thickness of 4 mm at the thickest point.

The layer 11 is made of aluminium sheet, while the layer 12 consists of stainless steel and as the flame side is particularly thermally resistant.

In the embodiment of FIG. 4, the second layer 12 now has a flange 12a and the first layer 11 has a crimp 11a, which engages around the flange 12a and thus mechanically connects the first layer 11 to the second layer 12.

FIG. 5 shows a further shielding element of a battery box according to the invention, which is designed in a manner similar to that in FIG. 4. In a manner differing from FIG. 4, the first layer is now made of aluminium or hot-dip aluminized steel (FAL) or aluminium-plated steel (ALP) or stainless steel. The second layer consists of a stainless steel sheet having a thickness of 0.2 mm.

On the side of the insulation layer 13 facing towards the second layer 12, there is now a further layer 14 made of an expanded metal or a nubbed metal layer. This serves to further strengthen the protection against thermal breakthroughs and as mechanical reinforcement for the shielding element.

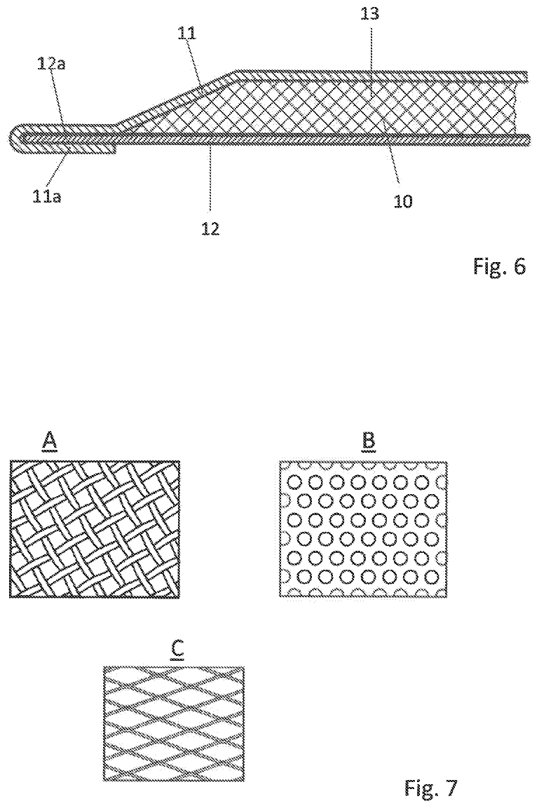

FIG. 6 shows a further example of a shielding element for a battery box according to the invention, corresponding to that in FIG. 3.

While in FIG. 3 the crimp 12a engages around the flange 11a in the direction of the side facing towards the battery box cover, in FIG. 6 the first layer 11 is provided with a crimp 11a and the second layer 12 is provided with a flange 12a, the crimp 11a engaging around the flange 12a in the direction of the inside of the battery box.

FIG. 7 shows examples of various specific and suitable materials for the layers 11, 12, 13 and 14 in the preceding examples of FIGS. 1 to 6. FIG. 7A shows a mesh or grid, for example made of stainless steel, FIG. 7B shows a pierced sheet, and FIG. 7C shows an expanded metal, which in each case can be used for these layers, but in particular for the second layer 12 and the additional intermediate layer 14.

FIG. 8 shows a battery box 2 in cross-section. Two battery modules 16 are arranged vertically one above the other therein, with a shielding element 10 arranged therebetween.

FIG. 9 shows the structure of this shielding element 10 in cross-section. It has a first outer metal layer 11 made of stainless steel and a second outer metal layer 12 made of aluminium. The layer 11 is crimped at its edge around the outer edge of the layer 12 and is thus connected to the latter. An insulation layer 13 made of glass fibres is provided between the layers 11 and 12, the glass fibres being coated with aluminium by vapour deposition.

FIG. 10 shows, in sub-figures 10a and 10b, an alternative design of a shielding element, for example of the shielding element in FIG. 9. The first outer layer 11 is once again made of stainless steel and engages around the outer edge of a second outer layer 12. The layer 12 is a tanged stainless steel sheet. The layer 12 is at least partially embedded in an insulation layer 13 made of mica coated with NBR (acrylonitrile 1,3-butadiene rubber) as the insulation layer.

1. A battery box for a traction battery, the battery box comprising:
a lower side and an upper side,
an edge region extending circumferentially between the upper side and the lower side,
a plurality of battery modules being arranged in the battery box, and
a flat shielding element formed of at least two layers arranged between the battery modules and the upper side or between two adjacent battery modules, said shielding element having a first outer metal layer and a second outer metal layer, the second outer metal layer arranged adjacent to a battery module and spaced apart from the first outer layer at least in regions, and the second outer metal layer comprised of a metal having a melting point Tₛ≥1000° C.

2. The battery box according to claim 1, wherein the first outer layer and/or the second outer layer comprises a metal sheet or other metal material.

3. The battery box according to claim 1, wherein the first outer layer is arranged adjacent to a further battery module and comprises a steel having a melting point Tₛ≥1000° C., or in that the first outer layer is arranged adjacent to the upper side of the battery box and comprises aluminium or steel.

4. The battery box according to claim 1, wherein the first layer and/or the second layer are microperforated, nubbed, and/or pierced.

5. The battery box according to claim 1, wherein an insulation layer is arranged between the two outer layers.

6. The battery box according to claim 5, wherein the insulation layer comprises a material which is stable up to at least 600° C., and the material of the insulation layer is fibres coated with aluminium by vapour deposition, rock wool, silicate fibres and the like, mica, and/or a cardboard containing fillers and binders.

7. The battery box according to claim 1, wherein the insulation layer is not self-supporting.

8. The battery box according to claim 5, wherein the metal of the first and/or the second outer layer comprises a stainless steel or a hot-dip aluminized steel or an aluminium-plated steel.

9. The battery box according to claim 1, wherein the first layer has a thickness D1, where 0.1 mm≤D1≤2.0 mm.

10. The battery box according to claim 1, wherein the second layer has a thickness D2, where 0.1 mm≤D2≤1 mm.

11. The battery box according to claim 1, wherein the insulation layer has a maximum or average thickness D3, where 0.5 mm≤D3≤10 mm.

12. The battery box according to claim 1, wherein the first layer and the second layer are crimped, clinched and/or welded to one another at least partially along their outer edges.

13. The battery box according to claim 1, wherein the shielding element lies in the battery box in a loose or clamped manner.

14. The battery box according to claim 1, wherein the shielding element is fastened to the cover and/or the tray of the battery box.
